(19) United States
(12) Patent Application Publication
(10) Pub. No.: US 2011/0074647 A1
(43) Pub. Date: Mar. 31, 2011

(54) ANTENNA MODULE

(75) Inventors: YE XIONG, Shenzhen (CN); WEI-DONG HAO, Shenzhen (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/753,227

(22) Filed: Apr. 2, 2010

(30) Foreign Application Priority Data
Sep. 28, 2009 (CN) 200910307839.9

(51) Int. Cl. H01Q 1/38; H01Q 1/48

(52) U.S. Cl. 343/846; 343/700 MS

(57) ABSTRACT

An antenna module includes a carrier and an antenna formed on the carrier. The carrier includes a first surface, a second surface, and a side surface. The antenna includes a first antenna portion and a second antenna portion. The first antenna portion includes a first radiation segment formed on the first surface and a second radiation segment formed on the side surface, the first radiation segment connects to the second radiation segment. The second antenna portion includes a third radiation segment formed on the first surface and a fourth radiation segment formed on the second surface, and the third radiation segment connects to the fourth radiation segment.

### BACKGROUND

1. Technical Field

The present disclosure relates to an antenna module, and more particularly to a built-in antenna module for a portable wireless terminal.

2. Description of Related Art

Generally, there are two kinds of antennas for portable wireless terminals: built-in antennas and external antennas. In contrast to the external antenna, the size of the built-in antenna is smaller, protected, and not easily damaged. Thus, the built-in antenna is commonly employed in portable wireless terminals.

Recently, more attention has been paid to developing smaller portable wireless terminals. Antennas, as key elements of portable wireless terminals, must be miniaturized accordingly.

Therefore, there is room for improvement within the art.

### BRIEF DESCRIPTION OF THE DRAWINGS

Many aspects of the present antenna module can be better understood with reference to the following drawings. The components in the various drawings are not necessarily drawn to scale, the emphasis instead being placed upon clearly illustrating the principles of the present antenna module

FIG. 1 is a schematic structure diagram of one embodiment of an antenna module.

FIG. 2 is similar to FIG. 1 but shown from another angle.

FIG. 3 is a cross-sectional view of the antenna module shown in FIG. 1.

### DETAILED DESCRIPTION

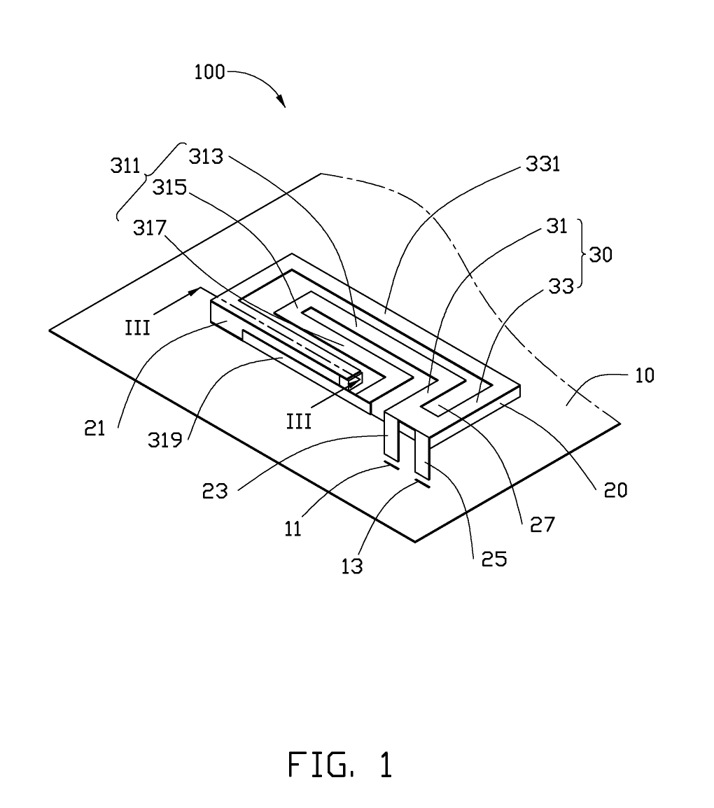

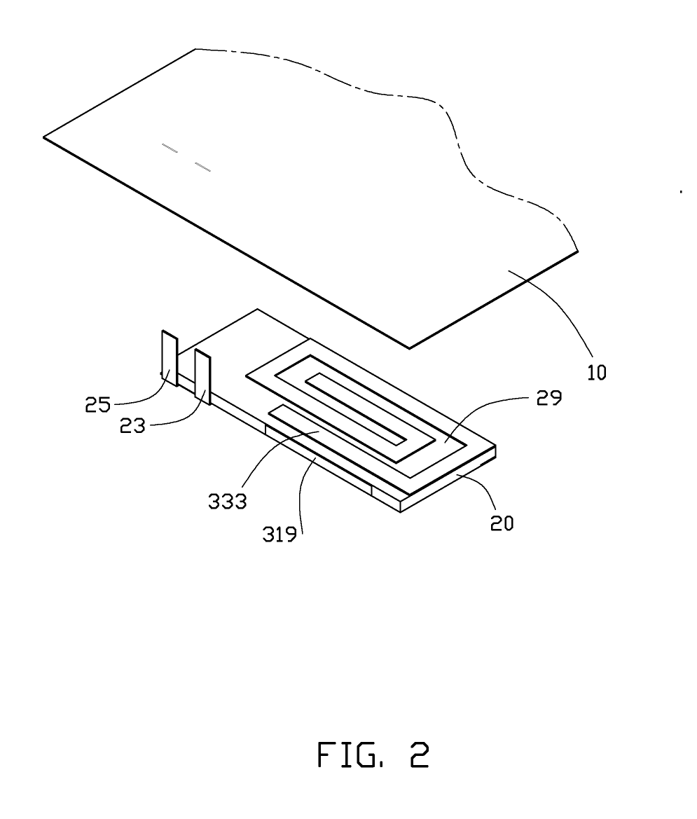

Referring to FIG. 1 and FIG. 2, an antenna module 100 according to one embodiment includes an insulating carrier 20 and an antenna 30 formed on the carrier 20. A circuit board 10 is disposed under the carrier 20 and the antenna 30. The circuit board 10 includes a feed terminal 11 and a ground terminal 13.

The carrier 20 includes a first surface 27, a second surface 29 substantially parallel to the first surface 27, and a side surface 21 substantially perpendicular to the first surface 27 and the second surface 29. A first feed wire 23 and a second feed wire 25 are formed on the side surface 21. When assembling the antenna module 100, the first feed wire 23 is connected to the feed terminal 11 and the second feed wire 25 is connected to the ground terminal 13.

The antenna 30 includes a first antenna portion 31 and a second antenna portion 33. The first antenna portion 31 can be used for sending and receiving high-frequency electromagnetic signals. In the present embodiment, the first antenna portion 31 includes a first radiation segment 311 formed on the first surface 27 and a second radiation segment 319 formed on the side surface 21. The first radiation segment 311 includes an L-shaped first bend portion 313, a connecting portion 315, and an L-shaped second bend portion 317. The first bend portion 313 and the second bend portion 317 are substantially parallel with each other. The first bend portion 313 connects the first feed wire 23 to the connecting portion 315. The second bend portion 317 connects the second radiation segment 319 to the connecting portion 315.

The second antenna portion 33 can be used for sending and receiving low-frequency electromagnetic signals. The length of the second antenna portion 33 is much greater than the length of the first antenna portion 31. In the present embodiment, the second antenna portion 33 includes a third radiation segment 331 formed on the first surface 27 and a fourth radiation segment 333 formed on the second surface 29. The third radiation segment 331 is roughly an incomplete rectangle and is located along the edge of the first surface 27. One terminal of the third radiation segment 331 connects to the second feed wire 25. The fourth radiation segment 333 is roughly shaped like a paper clip.

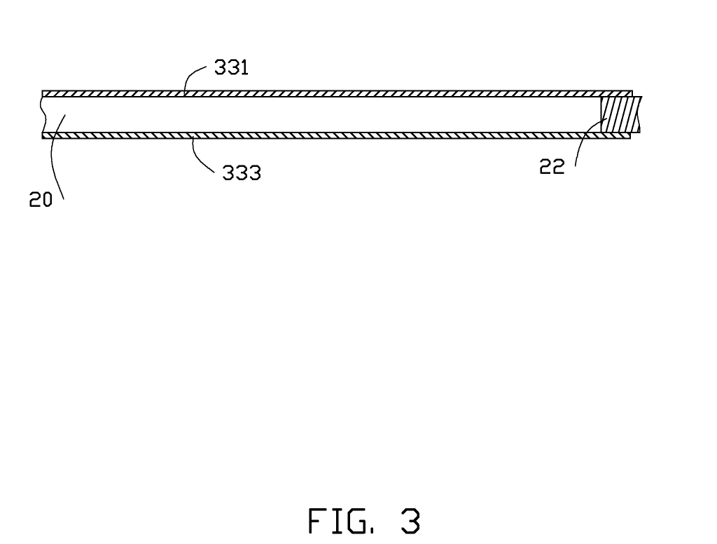

Referring to FIG. 3, a through-hole (not labeled) is formed in the carrier 20. The through hole is filled with conductive material to form a conductive portion 22. The conductive material may be the same material as the second antenna portion 33. The third radiation segment 331 connects to the fourth radiation segment 333 through the conductive portion 22.

The electromagnetic signals of the antenna 30 radiate through the first radiation segment 311, the second radiation segment 319, and the third radiation segment 331. The fourth radiation segment 333 can be used to increase the length of the second antenna portion 33. The circuit board 10 acts to shield electromagnetic radiation under the fourth radiation segment 333, therefore there is no electromagnetic signal radiating from the fourth radiation segment 333.

As detailed above, part of the antenna 30 is disposed on the second surface 29 and the side surface 21, thus the antenna 30 saves space. The second radiation segment 319 on the side surface 21 increases the effective radiation area and improves the radiation efficiency of the antenna 30.

It is to be understood that the first antenna portion 31 and a second antenna portion 33 may be shaped according to actual needs. The carrier 20 is a dielectric layer, and the dielectric constant of the carrier 20 can be greater than or equal to 8. The thickness of the carrier 20 is about 1 mm.

It is to be further understood that even though numerous characteristics and advantages of the present embodiments have been set forth in the foregoing description, together with details of structures and functions of various embodiments. The disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An antenna module, comprising:
a carrier including a first surface, a second surface, and a side surface; and
an antenna formed on the carrier;
wherein the antenna comprises a first antenna portion and a second antenna portion, the first antenna portion comprising a first radiation segment formed on the first surface and a second radiation segment formed on the side surface, the first radiation segment connecting to the second radiation segment; the second antenna portion comprises a third radiation segment formed on the first surface and a fourth radiation segment formed on the second surface, the third radiation segment connecting to the fourth radiation segment.

2. The antenna module as claimed in claim 1, wherein the length of the second antenna portion is much greater than the length of the first antenna portion.

3. The antenna module as claimed in claim 2, wherein the first radiation segment comprises an L-shaped first bend portion, a connecting portion, and an L-shaped second bend portion; the first bend portion and the second bend portion are substantially parallel with each other; the first bend portion connects to the second bend portion through the connecting portion, and the second bend portion connects to the second radiation segment.

4. The antenna module as claimed in claim 2, wherein the third radiation segment is an incomplete rectangle located along the edge of the first surface; the fourth radiation segment is shaped like a paper clip.

5. The antenna module as claimed in claim 2, further comprising a circuit board disposed under the carrier and the antenna, wherein the circuit board includes a feed terminal and a ground terminal; a first feed wire and a second feed wire are formed on the side surface; the first feed wire connects to the feed terminal, and the second wire connects to the ground terminal.

6. The antenna module as claimed in claim 5, wherein the first antenna portion and the second antenna portion are connected to the first feed wire and the second feed wire.

7. The antenna module as claimed in claim 1, wherein the dielectric constant of the carrier is greater than or equal to 8.

8. The antenna module as claimed in claim 1, wherein the thickness of the carrier is about 1 mm.

9. The antenna module as claimed in claim 1, wherein the carrier comprises a conductive portion, and the third radiation segment connects to the fourth radiation segment through the conductive portion.
